(19) United States
(12) Patent Application Publication
(10) Pub. No.: US 2003/0187742 A1
(43) Pub. Date: Oct. 2, 2003

(54) Personal authentication system and sales management system

(75) Inventor: Junichi Yamagishi, Tokyo (JP)

Correspondence Address: JORDAN AND HAMBURG LLP, 122 EAST 42ND STREET, SUITE 4000, NEW YORK, NY, 10168, US

(73) Assignees: Unirec Co., Ltd., Taito-ku (JP); Junichi Yamagishi, Taito-ku (JP)

(21) Appl. No.: 10/393,895

(22) Filed: Mar. 21, 2003

(30) Foreign Application Priority Data
Mar. 27, 2002 (JP) 2002-087429

(51) Int. Cl. G06F 17/60

(52) U.S. Cl. 705/18; 705/64

(57) ABSTRACT

The program for personal authentication in a mobile phone enables the mobile phone user to buy a commodity without cash and a card, and without entering a password.

A personal authentication system 1 includes a mobile phone 5, a reading adapter 7 and an authentication server 9. The mobile phone 5 can download a program for personal authentication from a web server 17. The mobile phone 5 can, according to the downloaded program, output a train of serial optical pulses that represents personal information. The reading adapter 7 can receive and read the output pulse train. The authentication server 9 registers the personal information and performs personal authentication based on the read pulse train.

### BACKGROUND OF THE INVENTION

1. Field of the Invention

The present invention relates to a personal authentication system for a game machine, a vending machine or the like that can be used without cash. The invention also relates to a sales management system for the sale of commodities or goods based on personal authentication.

2. Description of Related Art

A conventional system of this type is disclosed in Japanese unexamined patent publication No. 8-87655. The conventional system enables a user to buy a commodity from a vending machine without cash by using a mobile phone with an IC card inserted into the mobile phone. Personal information on the user is recorded on the IC card. Without the IC card, the user can buy no commodity from the vending machine.

Japanese unexamined patent publication No. 2000-56443 discloses a sales system that enables a user to buy a commodity from a vending machine without cash and a card. Each time the user buys a commodity from the vending machine, the sales system requires him or her to operate his or her mobile phone so as to send a password etc. to a sales center terminal through a network. This operation is complicated. When the user cannot communicate on the mobile phone through the network, he or she cannot be authenticated and can consequently buy no commodity.

### SUMMARY OF THE INVENTION

One object of the present invention is to provide a personal authentication system that can authenticate a user easily without a card or the like when he or she buys a commodity without cash.

Another object of the present invention is to provide a sales management system that enables a user to buy a commodity without cash, a card and the like.

A personal authentication system according to one aspect of the present invention includes a mobile means, a reading means and an authenticating means. The mobile means can output a signal representing personal information according to a program for personal authentication. The reading means can receive the output signal and read the received signal. The authenticating means can register the personal information and perform personal authentication based on the read signal. Consequently, the program for personal authentication enables personal authentication, without a password etc. entered into the mobile means.

The signal may be light, sound, vibration or a combination of them. In this case, the mobile means outputs an optical signal, a sound signal, a vibration signal or a combination of them representing the personal information according to the program for personal authentication. The reading means reads the output signal so that the personal authentication system can perform personal authentication.

The mobile means may be a mobile communication terminal with a communication facility. The communication terminal can hold normal communication. In addition, the light, sound and/or vibration output from the communication terminal can be utilized as a signal for personal authentication. It is consequently possible to perform personal authentication easily without an IC card or the like by using the communication terminal.

The personal authentication system may further include a managing means for generating the program for personal authentication based on the personal information. The mobile communication terminal can download the program for personal authentication into it from the managing means. It is consequently possible to perform personal authentication thereafter by merely downloading the program for personal authentication from the managing means into the mobile means.

A sales management system according to another aspect of the present invention includes the personal authentication system and a sales means for selling commodities, information or the like. The sales means is provided with the reading means and can sell the commodities, the information or the like on the basis of the personal authentication performed by the authenticating means. It is consequently possible to perform personal authentication according to the program for personal authentication and buy commodities, information or the like from the sales means. If the mobile means is a mobile communication terminal, it is possible to perform personal authentication thereafter by merely downloading the program for personal authentication from the managing means into the terminal, and to simply buy commodities, information or the like from the sales means.

### BRIEF DESCRIPTION OF THE DRAWINGS

FIG. 1 is a system diagram of a sales management system, which includes a personal authentication system, according to an embodiment of the present invention;

FIG. 2 is a block diagram of the signal reading process of the sales management system of FIG. 1;

FIG. 3 shows the waveform of a data row output from the MPU shown in FIG. 2;

FIG. 4 is a flowchart of a user registration procedure according to the embodiment;

FIG. 5 is a flowchart of a purchase procedure according to the embodiment.

### DETAILED DESCRIPTION OF A PREFERRED EMBODIMENT

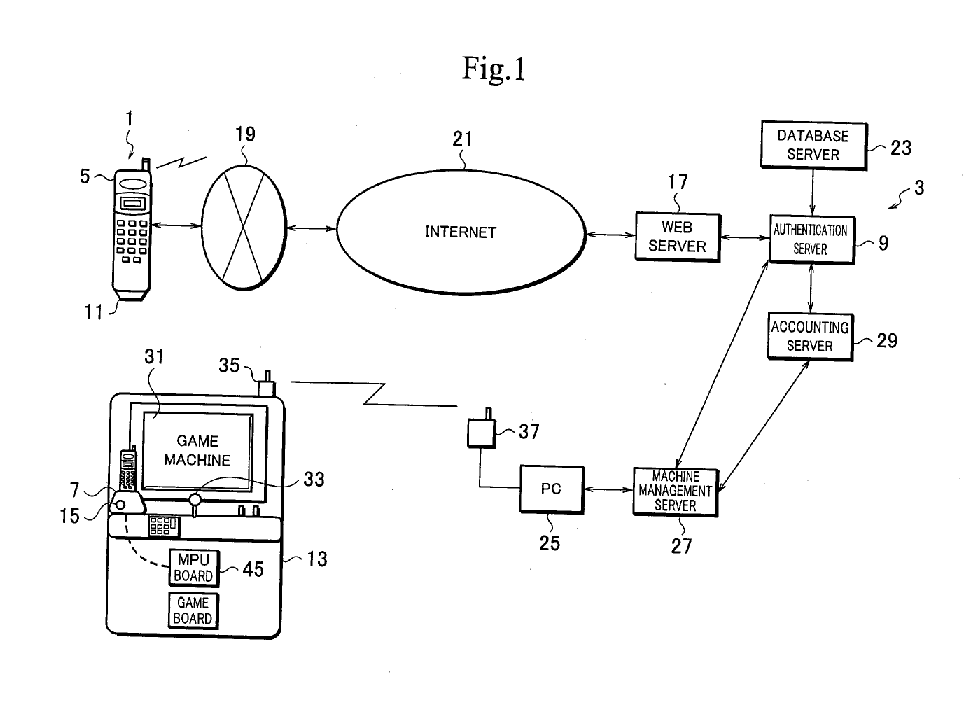

With reference to FIG. 1, a sales management system 3 embodying the present invention includes a personal authentication system 1.

The personal authentication system 1 includes a number of mobile phones 5, one of which is shown, a number of reading adapters 7 as optical readers, one of which is shown, and an authentication server 9. Each mobile phone 5 is a mobile means, which can execute a program for personal authentication to output a signal representing personal information on the mobile phone user. The mobile phone 5 is a mobile communication terminal with a communication facility.

The program for personal authentication may be a Java (trademark) application program. The mobile phone 5 has a browser that enables the application program to be downloaded and then executed.

The signal that represents personal information is light, but might be sound or vibration, or a combination of light, sound and vibration. According to this embodiment, it employs a light as the signal, the bottom of the mobile phone 5 is fitted with an optical signal transmitter 11.

The mobile phone 5 might, instead of being fitted with an optical signal transmitter 11, transmit an optical signal by means of the on-off control of its back light or the monochromatic inversion of its screen. If the signal were sound, the mobile phone 5 might control the ring tone of its speaker. If the signal were vibration, the mobile phone 5 might control the vibration of its vibration. Thus, the signal for personal authentication is light that can be output as an incoming call from the mobile phone 5. Alternatively, this signal might be sound or vibration that can be output as an incoming call from the mobile phone 5. Accordingly, the mobile phone 5 can be an ordinary one without a special output means for personal authentication, and can consequently be simple in structure.

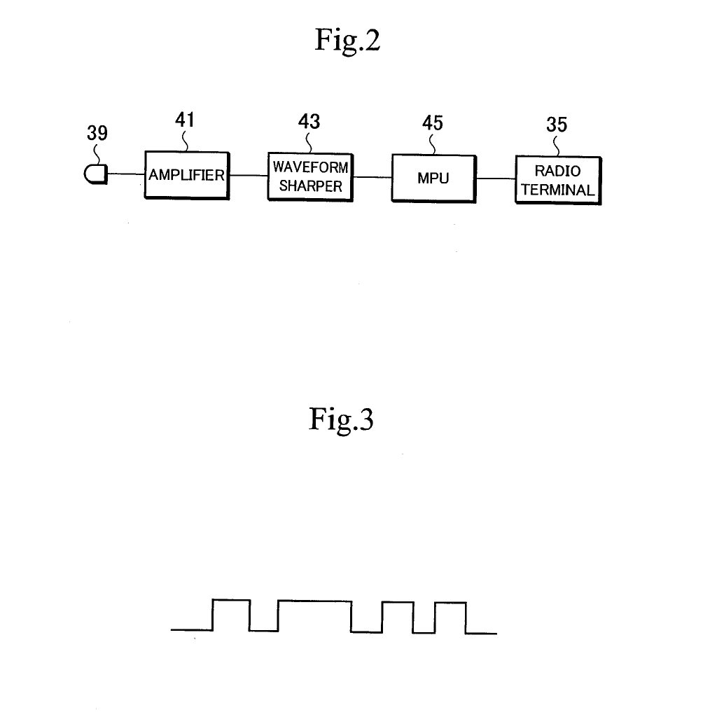

Each reading adapter 7 is mounted on a game machine 13 and provided with a photodiode 39 (FIG. 2). The optical signal transmitter 11 of the mobile phone 5 can be inserted into the reading adapters 7 so that photodiode 39 of the adapter can receive the optical signal transmitted from the transmitter 11. The reading adapter 7 serves as a reading means, which can read the signal input into it from the mobile phone 5.

If the signal were sound, the reading adapter 7 would receive the sound signal from the mobile phone 5 by means of a microphone. If the signal were vibration, the reading adapter 7 would receive the vibration from the mobile phone 5 by means of a pressure sensor. If the signal were a combination of light, sound and vibration, the reading adapter 7 would receive the signal from the mobile phone 5 by means of an appropriate combination of a photodiode, a microphone and a pressure sensor.

The reading adapter 7 is provided with a lamp 15, which flashes or blinks to indicate an error of personal authentication.

The sales management system 3 includes a web server 17 as a managing means, which generates programs for personal authentication based on the personal information registered in a database server 23 by the users of the mobile phones 5. The personal information may include telephone numbers and passwords. This information may also include methods of settlement, which may be credit card, cash and bank settlements.

The mobile phones 5 can be connected to the web server 17 by means of communication through a mobile communication network 19 and the Internet 21. Each mobile phone 5 can download the associated program for personal authentication into it from the web server 17.

The web server 17 is connected to the authentication server 9 which performs personal authentication with the signal read by each reading adapter 7. Therefore, the authentication server 9 is connected to the database server 23.

The sales management system 3 includes the personal authentication system 1, the game machines 13, a personal computer 25, a machine management server 27 and an accounting server 29.

Each game machine 13 is a sales means, which is provided with a screen 31 and a lever 33. A user can play a game by watching the game information on the screen 31 and operating the lever 33.

The game machine 13 is fitted with a radio communication terminal 35 for radio communication with a radio communication terminal 37, which is connected to the personal computer 25.

The personal computer 25 is connected to the machine management server 27. This server 27 stores tables of charges etc., each of which is associated with the machine number assigned to one of the game machines 13. The management server 27 is connected to the authentication server 9 and the accounting server 29.

The accounting server 29 is also connected to the authentication server 9 and accounts for the use of the game machines 13 so that settling companies can send the users debit notes for credit card, cash and/or bank settlements.

As shown in FIG. 2, the signal output from the photodiode 39 of the reading adapter 7 is input through an amplifier 41 and a waveform shaper 43 into an MPU 45, which outputs a signal to the radio communication terminal 35.

The photodiode 39 receives an optical signal as a train of serial pulses, which may represent “54356”, for example, generated as authentication information according to one of the programs for personal authentication. The MPU 45 outputs a data row for personal authentication as shown in FIG. 3.

With reference to FIG. 1, a user can access the web server 17 through the mobile communication network 19 and the Internet 21 by operating his or her mobile phone 5. The user can then download from the web server 17 the associated program for personal authentication, into which authentication information is incorporated.

When the user plays a game on one of the game machines 13, he or she inserts the optical signal transmitter 11 of his or her mobile phone 5 into the reading adapter 7 on the machine 13 so that the adapter 7 can read the optical signal transmitted from the transmitter 11. The photodiode 39 (FIG. 2) of the reading adapter 7 receives the transmitted optical signal so that the associated radio communication terminal 35 can output a data row for personal authentication. The output data row is input through the radio communication terminal 37 into the personal computer 25, which outputs a signal to the machine management server 27.

The machine management server 27 outputs a signal to the authentication server 9, which performs personal authentication with the personal information registered in the database server 23. If the authentication server 9 authenticates the user, this server 9 outputs a signal to the machine management server 27 and the accounting server 29.

The machine management server 27 outputs a signal to the personal computer 25, which outputs an authentication result to the radio communication terminal 37. This terminal 37 transmits the authentication result to the radio communication terminal 35 of the game machine 13. This makes the game machine 13 stand by so that the user can play a game on this machine 13.

The user can play a game by pressing the start button of the game machine 13 to display game information on the screen 31 of this machine, and by operating the lever 33 of the machine 13.

If the authentication server 9 does not authenticate the user, the radio communication terminal 35 of the game machine 13 receives an authentication result likewise. This makes the lamp 15 of the reading adapter 7 flash so that the user can know that he or she has not been authenticated.

When the game machine 13 starts to stand by, time is started to be counted. The time count is output through the radio communication terminals 35 and 37 and the personal computer 25 to the machine management server 27. The management server 27 outputs to the accounting server 29 the table of charges that is associated with the game machine 13, the playing time, etc. The accounting server 29 accounts for the playing time so that the appropriate settling company can send the user a debit note.

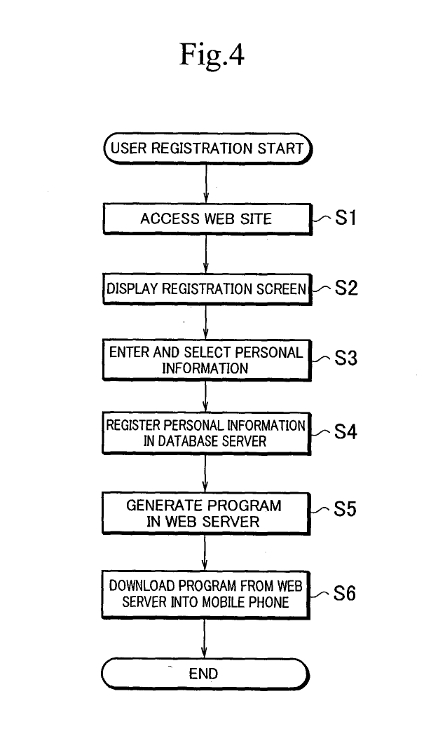

FIG. 4 shows a user registration procedure embodying the present invention.

In the first step S1 of this procedure, a user operates his/her mobile phone 5 to access the web site of the manager of any one of the game machines 13. The access to the web site makes the procedure move to the step S2, where the mobile phone 5 displays a registration screen.

In the next step S3, the user operates the mobile phone 5 to register personal information on him/her on the registration screen by entering his/her name, address, telephone number and password, and by selecting one of the methods of settlement, which include card and cash settlements.

In the next step S4, the entered information and the selected method are sent to the database server 23, where the personal information is then registered.

The registration of the personal information makes the procedure move to the step S5, where the web server 17 generates a program for personal authentication based on the personal information.

In the next step S6, the user operates the mobile phone 5 to access the web server 17 and download the program for personal authentication from this server into this telephone.

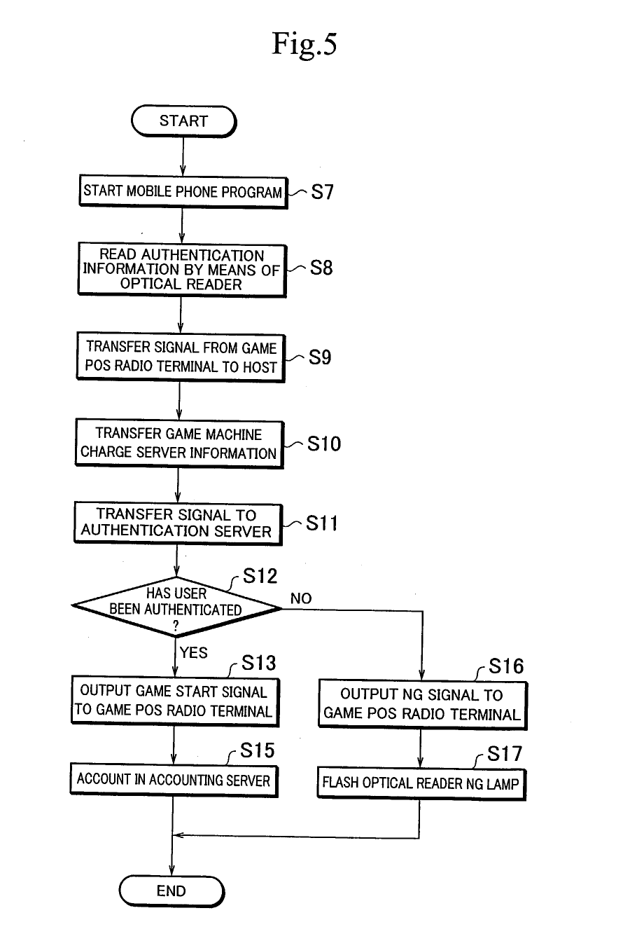

FIG. 5 shows a purchase procedure embodying the present invention. This procedure can be performed after the step S6 of downloading the program for personal authentication into the mobile phone 5.

In the step S7 of this procedure, the user operates the mobile phone 5 to start the downloaded program for personal authentication. This makes the optical signal transmitter 11 of the mobile phone 5 output an optical signal in the form of a train of serial pulses that represents authentication information.

In the next step S8, the user inserts the optical signal transmitter 11 of the mobile phone 5 into the reading adapter 7 on the game machine 13. This makes the photodiode 39 of the reading adapter 7 read the optical signal transmitted as authentication information from the signal transmitter 11.

In the next step S9, the radio communication terminal 35 of the game machine 13 outputs a data row to the personal computer 25 through the radio communication terminal 37.

In the next step S10, the machine management server 27 receives the data row from the personal computer 25, thereby transferring to the accounting server 29 the data row and information on the table of charges that is associated with the game machine 13.

In the next step S11, the machine management server 27 transfers the data row to the authentication server 9.

In the next step S12, the authentication server 9 determines whether the user has been authenticated. If the user has been authenticated, the procedure moves to the step S13, where the authentication server 9 outputs a game start signal through the machine management server 27, the personal computer 25 and the radio communication terminals 37 and 35 to the game machine 13. This makes the game machine 13 stand by so that the user can play a game on it.

When the game start signal is output to the game machine 13, time is started to be counted. The time count is input through the radio communication terminals 35 and 37, the personal computer 25 and the machine management server 27 into the accounting server 29. Then, the procedure moves to the step S15, where the accounting server 29 accounts for the time count. The accounting enables the appropriate settling company to send the user a debit note.

If it is determined in the step S12 that the user has not been authenticated, the procedure moves to the step S16, where the authentication server 9 outputs an NG (no good) signal through the machine management server 27, the personal computer 25 and the radio communication terminals 37 and 35 to the game machine 13. When the NG signal is input into the game machine 13, the procedure moves to the step S17, where the lamp 15 of the reading adapter 7 flashes to inform the user that he/she has not been authenticated.

In this way, a user can easily enjoy a game on any one of the game machines 13 by operating his or her mobile phone 5 to download the associated program for personal authentication. After the program is downloaded, the user can enjoy the game without particularly communicating through the mobile phone 5.

Accordingly, a user can easily enjoy a game on any one of the game machines 13 without cash and a card, and without entering his or her password etc. into his or her mobile phone 5.

A program for personal authentication is downloaded from the web server 17 to the associated mobile phone 5, but may be downloaded from another managing means. Alternatively, when one buys a mobile phone, a program for personal authentication may be incorporated into it in advance.

The mobile means is not limited to a mobile phone with a communication facility, but may be a mobile terminal without a communication facility if the terminal is provided with a program for personal authentication. In any case, the mobile means functions like a card for personal authentication.

The sales means is not limited to a game machine, but may be a vending machine for commodities.

The personal authentication system 1 is incorporated in the sales management system 3, but might be used as a door-unlocking system, with a reading means fitted to a door of a building, a vehicle, a safe or the like. The authentication system 1 might be applied to various means that need personal authentication.

The Internet 21 might be replaced by another network.

What is claimed is:

1. A personal authentication system comprising:
mobile means for outputting a signal representing personal information according to a program for personal authentication;
reading means for receiving the output signal and reading the received signal; and
authenticating means for registering the personal information and performing personal authentication based on the read signal.

2. The personal authentication system as set forth in claim 1, wherein the signal is light, sound, vibration or a combination thereof.

3. The personal authentication system as set forth in claim 1, wherein the mobile means is a mobile communication terminal with a communication facility.

4. The personal authentication system as set forth in claim 2, wherein the mobile means is a mobile communication terminal with a communication facility.

5. The personal authentication system as set forth in claim 3, and further comprising:
managing means for generating the program for personal authentication based on the personal information;
the mobile communication terminal being capable of downloading the program for personal authentication thereinto from the managing means.

6. The personal authentication system as set forth in claim 4, and further comprising:
managing means for generating the program for personal authentication based on the personal information;
the mobile communication terminal being capable of downloading the program for personal authentication thereinto from the managing means.

7. A sales management system comprising:
the personal authentication system as set forth in claim 1; and
sales means for selling commodities, information or the like;
the sales means provided with the reading means;
the sales means being capable of selling the commodities, the information or the like on the basis of the personal authentication performed by the authenticating means.

8. A sales management system comprising:
the personal authentication system as set forth in claim 2; and
sales means for selling commodities, information or the like;
the sales means provided with the reading means;
the sales means being capable of selling the commodities, the information or the like on the basis of the personal authentication performed by the authenticating means.

9. A sales management system comprising:
the personal authentication system as set forth in any one of claim 3; and
sales means for selling commodities, information or the like;
the sales means provided with the reading means;
the sales means being. capable of selling the commodities, the information or the like on the basis of the personal authentication performed by the authenticating means.

10. A sales management system comprising:
the personal authentication system as set forth in any one of claim 4; and
sales means for selling commodities, information or the like;
the sales means provided with the reading means;
the sales means being capable of selling the commodities, the information or the like on the basis of the personal authentication performed by the authenticating means.
